(19) United States
(12) Patent Application Publication
(10) Pub. No.: US 2018/0181569 A1
(43) Pub. Date: Jun. 28, 2018

(54) VISUAL CATEGORY REPRESENTATION WITH DIVERSE RANKING

(71) Applicant: A9.com, Inc., Palo Alto, CA (US)

(72) Inventors: Alexis Bogie Jarr, Seattle, WA (US); Sean Michael Bell, North Bend, WA (US); Erick Cantu-Paz, San Jose, CA (US); Apurva Charudatta Garware, Sunnyvale, CA (US); Francois Huet, Santa Cruz, CA (US); Tracy Holloway King, Mountain View, CA (US); Keiichiro Suzuki, Redmond, WA (US)

(21) Appl. No.: 15/389,251

(22) Filed: Dec. 22, 2016

(51) Int. Cl. G06F 17/30

(52) U.S. Cl. CPC G06F 17/3028; G06F 17/30265

(57) ABSTRACT

Embodiments described herein provide images representing a set of search results based on diversity between results of the search query. Images associated with a set of visually diverse items can be provided to provide a sample of items matching the search query across multiple types of categories. For example, search results can be grouped into types of categories and images from each of the types of categories can be grouped into subsets of visually related images (across one or more different visual attributes). A set of diverse representative images can be selected by taking at least one image from each of the groups of visually related images. The set of representative and diverse images can be displayed to provide an interesting, visually diverse, and aesthetically pleasing set of images to a user.

### BACKGROUND

Users are increasingly utilizing computing devices to access various types of content. For example, users may utilize a search engine to locate information about various items. Conventional approaches to locating items involve utilizing a query to obtain results matching one or more terms of the query navigating by page or category, or other such approaches that rely primarily on a word or category used to describe an item. However, some queries can capture items in multiple categories such that a user will likely not be interested in a majority of the search results and will have to paginate and/or browse through a large number of search results in order to find the items of interest to the user.

### BRIEF DESCRIPTION OF THE DRAWINGS

Various embodiments in accordance with the present disclosure will be described with reference to the drawings, in which:

FIG. 1A illustrates an example environment of a user submitting a search query in accordance with various embodiments;

FIG. 1B illustrates an exemplary category hierarchy of items related to a search query in accordance with various embodiments;

FIG. 1C illustrates an example display of a result set associated with a search query in accordance with various embodiments;

FIGS. 2A, 2B, and 2C illustrate an example approach for determining visually diverse images to display related to a search query in accordance with various embodiments;

FIG. 3 illustrates an exemplary interface including visual diverse category representations of items related to a search query in accordance with various embodiments;

FIG. 4 illustrates an example environment for determining visually diverse items related to a search query that can be utilized in accordance with various embodiments;

FIG. 5 illustrates an example process for determining and presenting visually diverse items across categories related to a search query that can be utilized in accordance with various embodiments;

FIG. 6 illustrates an example process for determining groupings of visually related items and using the groupings of visually related items to select visually diverse items across categories related to a set of results that can be utilized in accordance with various embodiments;

FIG. 7 illustrates an example computing device that can be used to implement aspects of the various embodiments;

FIG. 8 illustrates example components of a computing device such as that illustrated in FIG. 7; and

FIG. 9 illustrates an environment in which various embodiments can be implemented in accordance with various embodiments.

### DETAILED DESCRIPTION

Systems and methods in accordance with various embodiments of the present disclosure overcome one or more of the above-referenced and other deficiencies in conventional approaches to determining content to be provided for a user in an electronic environment. In particular, various embodiments analyze images in a search result set (e.g., a catalog of items that may include products, scenes, services, media, etc.) to identify visually diverse items across categories of the search results. This enables a user to obtain a representative set of images from a large and diverse result set and allows the user to identify the breadth of a result set in a small amount of information. For example, visually diverse items can be displayed showing the breadth of one or more categories related to a search query that may not be shown to a user through manual browsing due to the large number of results and limited attention span of the user. Further, presenting visually diverse images ensures that visually identical or similar items will not be presented to a user, leading to more efficient presentation of search results and a better understanding by a user of a large set of search results.

In accordance with various embodiments, a user can obtain visually diverse images related to a search query across a catalog of items (e.g., products, media, services, etc.) based on visual attributes associated with the results of the search query. The visually diverse images provide users a sample of items matching the search query across multiple categories through a small number of visually diverse images capturing the items contained in the search results. For example, the search results can be grouped into similar groups of images based on one or more visual attributes and one image from each group of images can be selected for display in order to provide a visual diversity of the search result set to a user. As such, search results can be grouped into categories and images from each of the categories can be grouped into subsets of visually related images (across one or more different visual attributes). A set of representative and diverse images can be selected from each of the groups of visually related items and displayed to ensure an interesting, visually diverse, and aesthetically pleasing set of images are provided to a user. As such, a small result set of representative, diverse items can be provided for display that are adapted to one or more categories across the result set to provide a diverse sampling of results to the user. Accordingly, a user can quickly and easily understand the catalog breadth for broad category searches and/or ambiguous search terms.

For example, an ambiguous or broad search term that includes multiple different types of categories can have a representative set of items presented for the user to quickly and easily review in order to understand the breadth of the search results. For instance, a search query for a movie franchise may have products associated with it across many categories including movies, television shows, clothing, novelty goods, etc. It may not be clear what type of product a user is interested in when searching for a broad category like a movie franchise. As such, embodiments can identify categories within the result set and provide a smaller set of representative, diverse, and aesthetically pleasing set of images that capture the breadth of the results without requiring the user to browse through the entire catalog to obtain an idea of the different products within the matching result set. For example, embodiments may rank categories as well as items within the respective categories based on diversity between items to provide a cross-section or sampling of different types of items contained therein. For instance, embodiments may use visual diversity between images associated with the result set of items to provide diversity across one or more categories within the result set. Embodiments may use visual similarity scores, rankings of visually related and/or similar items, visual attributes/categories, etc., and other visually related measurements to identify diverse items within a subset that provide an interesting, diverse, and relevant cross-section of the items within the search results.

This approach enables users to quickly and easily obtain a cross-section of the different items within a result set without having to browse through each of the result pages. Additionally, such approaches allow for displaying items that a user will be more likely to view and/or purchase, in order to improve the user experience and help the user more quickly locate items of interest. In addition to improving the user experience, showing items that are more likely to result in views and/or transactions can improve the revenue for the provider of the items, or other such party or entity.

Various other applications, processes, and uses are described below with respect to various embodiments, each of which improves the operation and performance of the computing device) on which they are implemented, for example, by providing highly visually diverse images for display in an organized, economic fashion, as well as improving the technology of image similarity and image diversity.

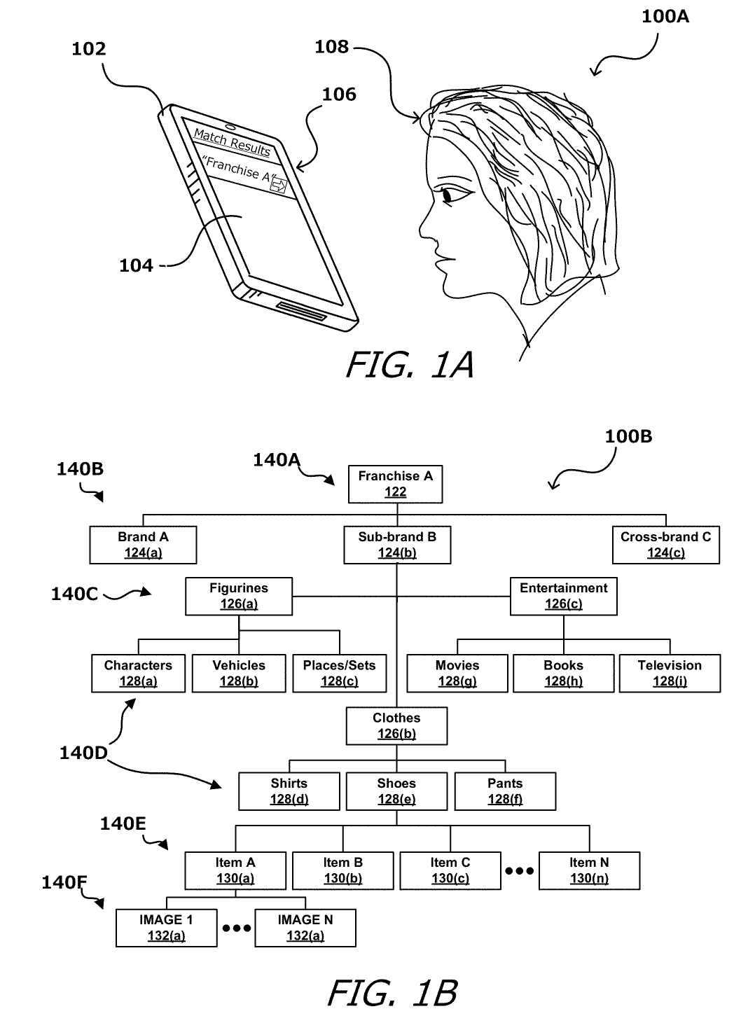

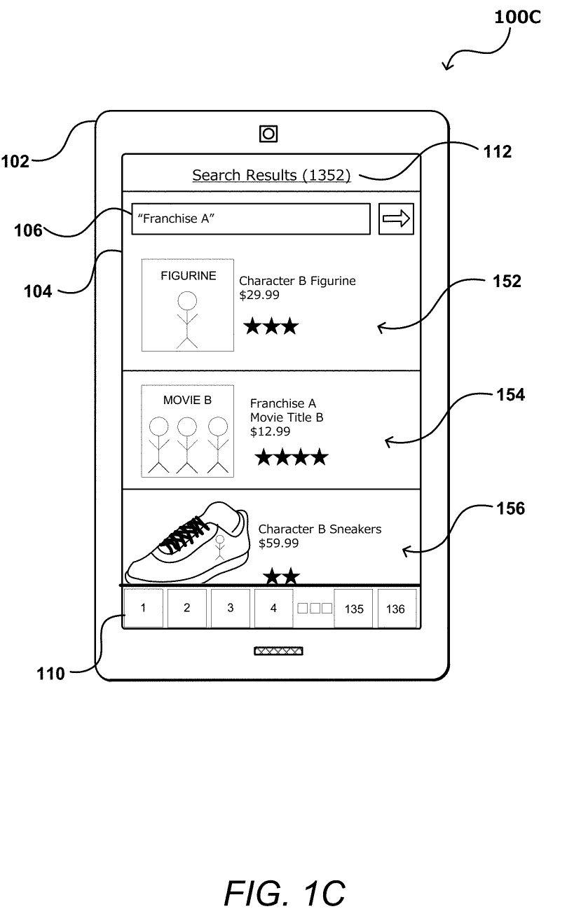

FIG. 1A illustrates an example situation 100 in which an interface on a display screen 104 of a computing device 102 can be used to search for items provided through an electronic marketplace or other such service. Although a portable computing device (e.g., a smart phone, an electronic book reader, or tablet computer) is shown, it should be understood that any device capable of receiving and processing input can be used in accordance with various embodiments discussed herein. The devices can include, for example, desktop computers, notebook computers, electronic book readers, personal data assistants, cellular phones, video gaming consoles or controllers, wearable computers (e.g., smart watches or glasses), television set top boxes, and portable media players, among others. In this example, a user 108 has entered a search query 106 that causes a set of search results to be displayed on the display screen 104 as shown in FIG. 1C.

In this example, however, the user submits a search query that is associated with items across a large number of categories, sub-categories, and/or other classifications. For example, the user may enter a search query for the name of a movie franchise (e.g., “Franchise A”) that has thousands of items across a wide-variety of brands, sub-brands, categories, and/or sub-categories. For instance, as shown in FIG. 1B, the search query “Franchise A,” matches items that are associated with a variety of brands 124(a), sub-brands 124(b), cross-brands 124(c) and a variety of categories 140C, and sub-categories 140D in a hierarchical product tree 100B that may cover thousands of items. Accordingly, the search request may return a wide-variety of items that the user has little or no desire to purchase.

FIG. 1B illustrates an image matching hierarchical data map showing a variety of different levels of categories 140B and sub-categories 140C-140D of a hierarchical organization of a result set related to a search query 140A. The first set of categories 140B that defines the segmentation of the result set in the example shown in FIG. 1B includes brands 124(a), sub-brands 124(b), and cross-brands 124(c). Additionally, the hierarchical data map includes categories 140C, sub-categories 140D, and items 140E that may match or be relevant to the search query 140A (e.g., “Franchise A”). As mentioned above, some queries 140A may have a large number of products associated with a search query. For example, a search query related to a movie franchise (e.g., “Franchise A”) may be associated with different brands 124(a)-124(c) (e.g., brand A, sub-brand B, cross-brand C, etc.) that may each reference the movie franchise or characters, items, places, etc. associated with that movie franchise (e.g., a character, logo, theme, title, etc.). Each of these references may be included on many different types of products and those products may be captured in a search query. For instance, as shown in FIG. 1B, the search query “Franchise A” may return branded products as well as be included on products for sub-brands, cross-brands, etc. Accordingly, a search query may result in many different types of products that are associated with many different types or brands, sub-brands, etc. that a user may not be interested in.

Further, each of the brands 124(a)-124(c) may include a variety of different products 410(a)-410(d) across multiple different types of product categories 126(a)-126(c) and sub-categories 128(a)-128(e). For instance, sub-brand 124(b) which includes at least a reference to the search query in at least some of the items associated therewith may cover products in the product categories 126 of figurines 126(a), clothes 126(b), and entertainment 126(c) to name a few (there may be many others). Further, the products 410 may include multiple different sub-categories 128 for each category 126. For instance, for the category of figurines 126(a), matching products may include product sub-categories of characters 128(a), vehicles 128(b), and places/sets 128(c). Although not shown, each of the sub-categories 128 may have additional sub-categories and numerous products 410 that include at least a reference to the search query 122. For example, the category of clothes 126(b) includes items 140E having sub-categories of shirts 128(d), shoes 128(e), and pants 128(f) (as well as others). Each of the sub-categories can have one or more items 140E. For instance, there could be tens or hundreds of different shoes that are branded or related to the movie franchise “Franchise A” as shown by “Item A” 130(a), “Item B” 130(b), “Item C” 130(c), through “Item N” 130(n).

However, there may be many different types of categories that could be selected to segment and divide the result set into many different hierarchical item trees or data maps. As such, many different types of 1^{st} level categories 140B could be selected including, for example, product types (e.g., figurines), product categories (e.g., entertainment media, toys, etc.). Depending on the first category identified and selected, the hierarchical data map organizing the result set could look very different and result in different sets of interesting and/or diverse items under the corresponding sub-categories.

FIG. 1C illustrates an example display 104 of a result set 152-156 associated with a search query 106 in accordance with various embodiments. As shown in FIG. 1C, the search query 106, and the search results including a displayed results list 152-156 that includes a variety of content items (e.g., products 152-156) that include relevant results to the search query. However, the result list 152-156 may include only a small subset of the large number of content items captured by the search query 106. Accordingly, a wide variety of products may be identified as matching the search query that could be relevant to the user. For instance, as shown by the search results identifier 112, the search query may match or be associated with 1352 items that may cover a large number of different types of products, brands, sub-brands, cross-brands, etc., as discussed above. Browsing through the large number of results may be burdensome and confusing to a user since the search results cover so many different products, brands, etc. For instance, in the search shown in FIG. 1C, 1352 search results are included in the results list across multiple different pages 110 (e.g., 136 different pages of 10 item results each) of search results. While the variety of products may be relevant to the broad search query (“Franchise A”), the user may not be interested in each of the products. Thus, the user may have to select a large number of different pages of products in order to browse through the large number of products to find the appropriate product in which they are searching. This can be time-consuming, annoying, and burden-some on the user.

The user can attempt to further refine the search results in an attempt to find the item the user desires. For example, the user can submit another query, navigate the search results, apply refinements to reduce the items displayed, or other such approaches that rely primarily on a word or category used to describe an item. However, such approaches can make it difficult to locate items based on appearance or aesthetic criteria, such as a style or objects depicted. Further, such approaches require continued feedback from the user and rely on the user's ability to describe the specific features and/or categories they are looking for. For example, the specific features of an item such as jewelry, artwork, clothing, etc. can include patterns, colors, shapes, etc. that may be desired but might be difficult to textually describe. Various approaches may obtain a similar set of results, or similar display of items, such as when the user navigates to a page corresponding to that type of content. However, while such approaches can be very useful and beneficial for users in many instances, there are ways in which the exposure of the user to items of interest can be improved. The ability to display items a user desires can help the provider of the items, as the profit and/or revenue to the provider will increase if items of greater interest to the user are provided.

Accordingly, embodiments attempt to determine items from the result set that provide a broad and diverse sampling of the different items and images contained in the search results across multiple categories without requiring the user to provide specific feedback and/or browse through each search result. Image data associated with the search results can be analyzed in order to organize items that are at least visually related, as described herein with regard to visual similarity scores, rankings of visually related and/or similar items, visual attributes/categories, user data, and other data, etc. For example, the result set of items can be organized into sets or groupings of items sharing one or more attributes. Thus, visually related items can be grouped together to allow the system to ensure that a diverse set of images are displayed to the user from the search results. This allows users to view diverse items in a visually economical display. Such approaches can improve the likelihood of clicks, purchases, and revenue to the provider of those items by expanding the user's understanding of the result set and provide an aesthetically pleasing and enticing summary of matching items to a user.

Items can include products, media content, services, and/or any other content provided through an electronic marketplace. An electronic marketplace can provide a catalog of items that are organized in different item categories, where each item category can have subcategories. In accordance with various embodiments, a user can obtain a visually diverse and cross-category sampling of a set of search results that may provide the user with a deeper understanding of the breadth and variety of results associated with a search query. As such, a sampling of search results can be provided in an efficient and easy to browse interface based on diversity between visual characteristics of the set of items. While movie franchise-related examples such as movies, characters, figurines, etc. will be utilized throughout the present disclosure, it should be understood that the present techniques are not so limited, as the present techniques may be utilized to determine visual similarity and present a set of visually diverse items in numerous types of contexts (e.g., digital images, art, physical products, media content, etc.), as people of skill in the art will comprehend.

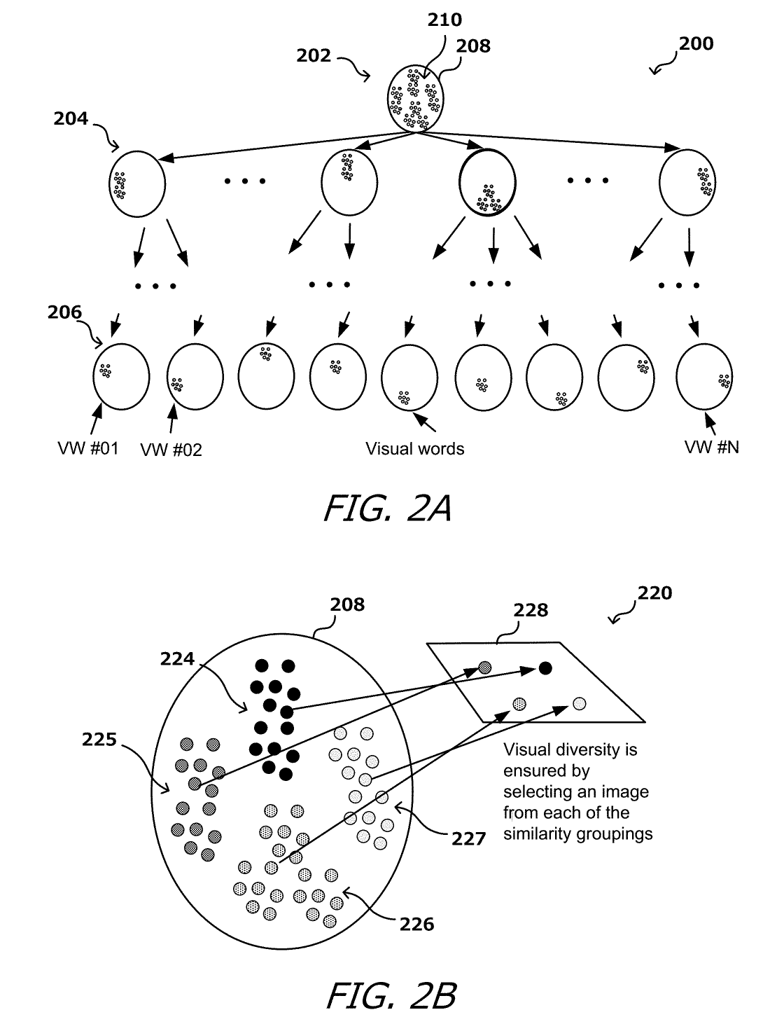

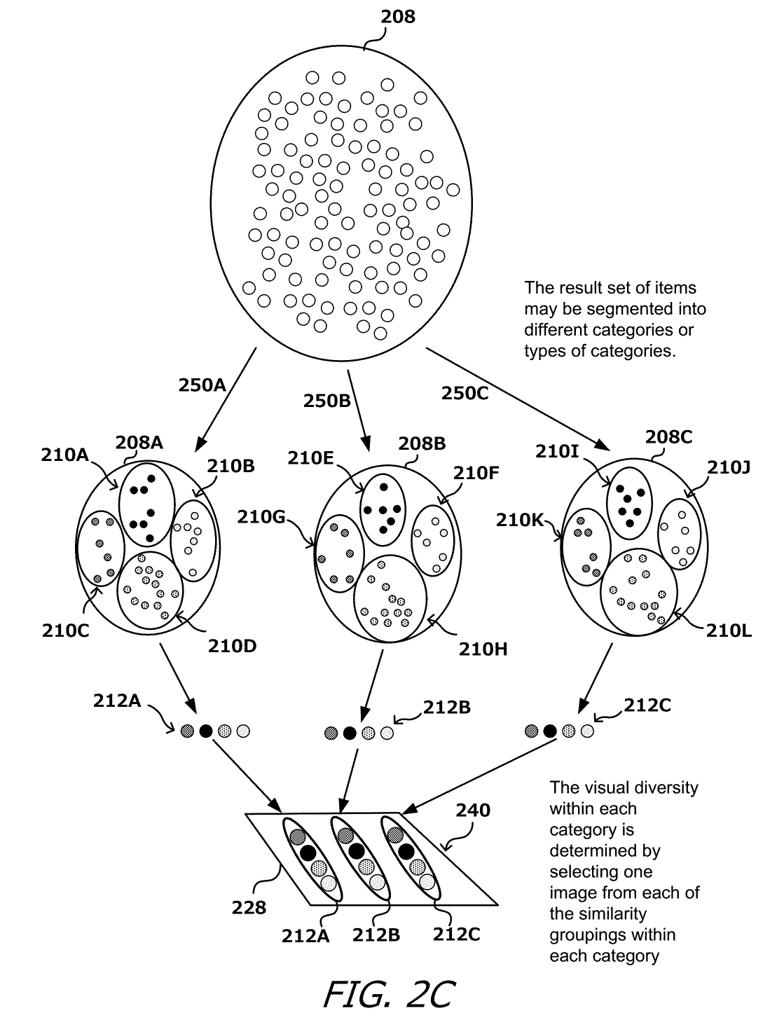

FIG. 2A illustrates an example representation of a hierarchical structure 200 that can be used in accordance with various embodiments. As described, a plurality of images for a catalog of items in an electronic catalog can be analyzed to identify visually related items. Analyzing the images to identify visually related items can include determining a feature vector for each image and organizing similar feature vectors in a hierarchical structure. An example hierarchical structure includes an alternate nearest neighbor tree (ANNT). In various embodiments, a feature vector includes one or more feature descriptors (or visual attributes). In should be noted that each feature vector is associated with an image and organizing feature vectors is, at least with respect to the hierarchical structure, synonymous with organizing the plurality of images. The visually related items organized in a hierarchical structure can allow for selecting visually diverse items across a set of search results.

Prior to recursively partitioning the plurality of images into clusters/groups, the images are analyzed to determine feature vectors for each image. The feature vectors are then clustered based on the similarity between the feature vectors. The clustering can be in view of one of a number of dimensions. For example, the images can be clustered in a shape dimension, where items are clustered based on their visual similarity as it relates to shape. Other dimensions include, for example, a color dimension, a size dimension, a pattern dimension, among other such dimensions. The clustered feature vectors make up the nodes of the hierarchical structure 200. In some embodiments, the feature vectors may be clustered by utilizing a conventional hierarchical k-means clustering technique, such as that described in Nistér et al., “Scalable Recognition with a Vocabulary Tree,” Proceedings of the Institute of Electrical and Electronics Engineers (IEEE) Conference on Computer Vision and Pattern Recognition (CVPR), 2006.

As shown in FIG. 2A, the clusters can exist at multiple levels. For example, hierarchical structure 300 includes a first level 202, a second level 204, up to a Nth level 206. At the root of the hierarchical structure 200 is cluster 208. Cluster 208 includes the catalog of items 210. At the second level 204 there are N clusters, each cluster representing roughly 1/n of the items of the catalog of items. At the third level 206 there are around n̂2 clusters, each representing approximately 1/(n̂2) of the items of the catalog of items. Although FIG. 2A shows the clusters arranged hierarchically, non-hierarchical clusters may also be used. Additionally, more or fewer clusters may be created depending on the types and variety of the images being analyzed.

In accordance with various embodiments, there are a number of ways to determine the feature vectors. In one such approach, embodiments of the present invention can use the penultimate layer of a convolutional neural network (CNN) as the feature vector. For example, classifiers may be trained to identify feature descriptors (also referred herein as visual attributes) corresponding to visual aspects of a respective image of the plurality of images. The feature descriptors can be combined into a feature vector of feature descriptors. Visual aspects of an item represented in an image can include, for example, a shape of the item, color(s) of the item, patterns on the item, etc. Visual attributes are features that make up the visual aspects of the item. The classifier can be trained using the CNN.

In accordance with various embodiments, CNNs are a family of statistical learning models used in machine learning applications to estimate or approximate functions that depend on a large number of inputs. The various inputs are interconnected with the connections having numeric weights that can be tuned over time, enabling the networks to be capable of “learning” based on additional information. The adaptive numeric weights can be thought of as connection strengths between various inputs of the network, although the networks can include both adaptive and non-adaptive components. CNNs exploit spatially-local correlation by enforcing a local connectivity pattern between nodes of adjacent layers of the network. Different layers of the network can be composed for different purposes, such as convolution and sub-sampling. There is an input layer which along with a set of adjacent layers forms the convolution portion of the network. The bottom layer of the convolution layer along with a lower layer and an output layer make up the fully connected portion of the network. From the input layer, a number of output values can be determined from the output layer, which can include several items determined to be related to an input item, among other such options. CNN is trained on a similar data set (which includes franchise-related products, jewelry, clothing, cars, books, food, people, media content, etc.), so it learns the best feature representation of a desired object represented for this type of image. The trained CNN is used as a feature extractor: an input image is passed through the network and intermediate outputs of layers can be used as feature descriptors of the input image. Similarity scores can be calculated based on the distance between the one or more feature descriptors and the one or more candidate content feature descriptors and used for building a relation graph.

A content provider can thus analyze a set of images and determine items that may be able to be associated in some way, such as including a character from a franchise, products having a similar style, or through other visual features. New images can be received and analyzed over time, with images having a decay factor or other mechanism applied to reduce weighting over time, such that newer trends are represented by the relations in the classifier. A classifier can then be generated using these relationships, whereby for any item of interest the classifier can be consulted to determine items that are related to that item visually.

In various embodiments, in order to cluster items that are visually related yet distinct, it can be desirable in at least some embodiments, to generate a robust representation of items in the catalog of items. A robust representation is desirable in at least some embodiments, to cluster items according to one or more visual aspects represented in images. A CNN can be used to learn a descriptor corresponding to, e.g., a size, a shape, patterns, etc. of the item, etc., which may then be used to cluster relevant content.

In addition to providing a cluster descriptor for each cluster, a visual word is provided for each cluster. According to some embodiments, the visual words are labels that represent the clusters. Accordingly, by excluding location information from the visual words, the visual words may be categorized, searched, or otherwise manipulated relatively quickly.

FIG. 2B illustrates an example 220 for using the visual similarity scores and groupings to select visually diverse items from a set of items. As described, visual diversity across a set of items may be determined by grouping the items based on a similarity across one or more visual attributes and selecting a single image from the grouping of similar items. By grouping similar items across one or more visual attributes and by only selecting a limited number of results (e.g., one item) from each of the groupings, embodiments can ensure visual diversity and a broad set of diverse items are selected within a result set. Accordingly, embodiments may provide a summary of the range of visual variety present in a grouping of items across one or more categories or sub-categories. The visual attributes may include one or more of a variety of dimensions (color, size, shape, texture, pattern, feature descriptors, etc.).

The specific item selected out of the similarity groupings may be determined through any suitable method. For example, a ranking algorithm may be applied to each of the items and the highest ranked item within the similarity grouping may be selected to represent the grouping. The ranking algorithm may use a weighting of various factors that provides context for the search query and the user to provide the most diverse and appropriate sampling of categories and images. For example, the ranking algorithm may include a weighting based on a variety of factors including purchase history, success of previously presented images based on similar user and search queries, session data including other search queries, products purchased or viewed, a third party website that the user originated from, etc., as well as any other relevant information to determine the most aesthetically pleasing and enticing product for a specific user to be presented. Moreover, the order that the selected images are displayed in may be based on a ranking and/or relevance score incorporating the ranking for the user.

Additionally, in some embodiments, an image processing algorithm may be applied to select the representative item from the similarity grouping. For example, one example approach to selecting a representative item is to determine a cluster descriptor of a cluster/group of items. As described, a cluster includes a plurality of visually related items. The plurality of visual related items in the cluster can be grouped into subgroups, where each subgroup can be related by a particular visual aspect. As shown in FIG. 2B, cluster 208 includes a plurality of items. The items are grouped in subgroups 224-227. Like feature vectors, cluster descriptors may be viewed as vectors in a vector space. Furthermore, cluster descriptors may be based at least in part on the feature vectors of the clusters and/or subgroups in the cluster that they characterize. For example, a cluster descriptor may be calculated for a cluster and/or subgroup, where the cluster descriptor corresponds to a point in the descriptor space that is a mean and/or a center (e.g., a geometric center) of the feature vectors in the cluster and/or subgroup. Accordingly, the item that is nearest the mean and/or center of the feature vector may be selected as the representative item for the similarity group of items.

Further, in some embodiments, a number of similarity groupings as well as a number of items within each similarity grouping may be determined by the number of items in the subset of items, the display preferences of the system, and/or the size and dimensions of the display screen. For example, the system may be configured to identify four visually diverse items corresponding to four visually diverse images from the result set. Accordingly, the result set may be divided into four separate similarity groupings and a single item may be selected from each of the similarity groupings. Alternatively and/or additionally, in some embodiments, eight visually diverse images may be identified and the corresponding number of similarity groupings may be doubled to eight or two different items may be selected from each similarity grouping. Either way, the images within the item set may be mapped using one or more similarity scores obtained for each image and the resulting similarity mapping of images for the result set may be segmented into separate groupings. Accordingly, in some embodiments, the inherent diversity amongst the set of images may dictate the size of the groupings between the images in the set of images.

For example, if there are 100 items in a result set, similarity scores may be determined for each of the images using the techniques described above and mapped to a similarity mapping. The resulting set of items may then be segmented into groupings based on the number of determined similarity groupings. Thus, a result set of images that are very similar may have similarity groupings that are much tighter than a result set of images that are less similar. Accordingly, diversity can be determined irrespective of the objective similarity between the images in the result set.

In accordance with various embodiments, based on the viewable area of a display screen the number of selected representative diverse items and/or images may be updated. For example, a display screen of a portable computing device may be different in size and thus include a different number of representative images than a display screen of a desktop computing device. In the situation where the display screen size changes (e.g., due to a change in orientation of a display screen), the number of representative items displayed can be updated as well.

In accordance with various embodiments, it should be understood that present techniques are not limited to particular types of search queries and/or types of products, as the present techniques may be utilized to determine similarity and present a diverse set of items in numerous types of contexts (e.g., video content, audio content, scenes, actors, action scenes represented in media, drama scenes represented in media, as well as any other media that can be reduced to a feature vector), as people of skill in the art will comprehend.

FIG. 2C illustrates an example representation 240 of a diverse set of items 212A-212C being displayed representing a result set of items 208 associated with a search query that can be used in accordance with various embodiments. In accordance with various embodiments, using the approach of similarity clustering can enable a user to obtain a cross-section of a result set of items (e.g., products, media, services etc.) based on categories and visually diverse characteristics associated with the items in the result set. Viewing a cross-section of such results in this way provides users an overview of the items available in a result set by displaying a small number of visually diverse subsets of items, each set exemplified by one representative item (also referred to as an exemplar).

As described, the similarity clustering technique can be used to identify similarities between items and organizing the items into similarity clusters/groups. However, it may be beneficial to segment 250 the set of items into subsets based on categories and sub-categories in order to show the diversity between categories and focus the results on particular important categories within the result set. Accordingly, as shown in step 250, the result set 208 associated with the search query may be segmented into a one or more categories or sub-categories. Any number of categories or sub-categories may be identified and used to segment the search result set to provide an interesting and diverse sampling of the search results. Additionally, the categories may be provided at different levels of the product search result hierarchy such that some items may be separated into sub-categories while other items may be grouped according to categories (e.g., toys and games (category) vs. figurines (sub-category)). Categories may include, for example, any potential attribute or characteristic shared by two or more of the items within the result set. Thus, the categories or types of categories may include any dimension of the result set that can differentiate amongst items in the result set. For example, categories can include different product features (e.g., size, dimensions, length, etc.), visuals aspects (e.g., color, pattern, brand, etc.), metadata (product segment, target demographic of product, etc.), and/or any other information associated with the items within the result set that can be used to differentiate across the result set. Different result sets may include different categories and types of categories based on the subject matter of the result set and the categories of interest may change depending on the items within the result set as well.

Moreover, in some embodiments, different hierarchical data maps of the result set can be generated and categories or types of categories may be selected from one or more of the different hierarchical data maps in order to obtain the most diverse set of items across categories. As discussed above in reference to FIG. 1B, the different dimensions used to organize the result set into a hierarchy can drastically alter the organization of the items into different categories and types of categories. Accordingly, by allowing selection of different categories from different hierarchical data mappings of a result set, a result set can be divided into diverse and interesting cross-sections of items. In some embodiments, items may be limited to one category selection and then removed from other hierarchical groupings if they are selected from one of the hierarchical data mappings as a category selection. In other embodiments, the duplicate items may remain and could potentially be included in two different visual similarity groupings for selection. In such embodiments, the overall diversity between selected images may be used to ensure diversity across the final selected images that are presented for display. Accordingly, in some embodiments, the result set may be segmented into identified, ranked, and selected categories to obtain a plurality of relevant, interesting, and diverse groupings of the search results within the search results. The categories may be ranked and selected based on the number of results within each category, the diversity within those categories, user data and/or aggregate behavioral user data related to the trendiness/success of each category. Thus, the set of items in the search results can be segmented into different subsets of items 208A-208C based on identified and ranked categories where each of the subset of items 208A-208C associated with different categories. These categories may be selected from different hierarchical data mappings of the search results or from different categories within the same hierarchical data mapping to ensure diversity and interesting representations of the result set.

As shown in FIG. 2C, each of the subsets of items 208A-208C within each of the categories can be grouped into subgroups 210A-210L based on similarity across a wide-variety of visual attributes. For each cluster, the items can be analyzed to identify the item to select to represent the group of visually similar items. For example, for the first segmented subset of items 208A, the four subgroups 210A-210D of items can be represented by one item from each of the subgroups 210A-210D. As described above, each of the items within the subgroups can be ranked according to user data, item popularity, diversity amongst different items, and/or through any other suitable attributes. As such, for each grouping of similar items within each sub-group, an item can be selected based on the ranking and/or relevance of the item to the user. Accordingly, each sub-group of visually similar items may have an item selected and included in a visually diverse subset of items 212A. The process can be repeated for each of the segmented categories to create a diverse set of items corresponding to the various segmented categories for display. Accordingly, the visually diverse set of selected items may be provided and displayed as a visually diverse sampling of the items within the result set associated with the search query.

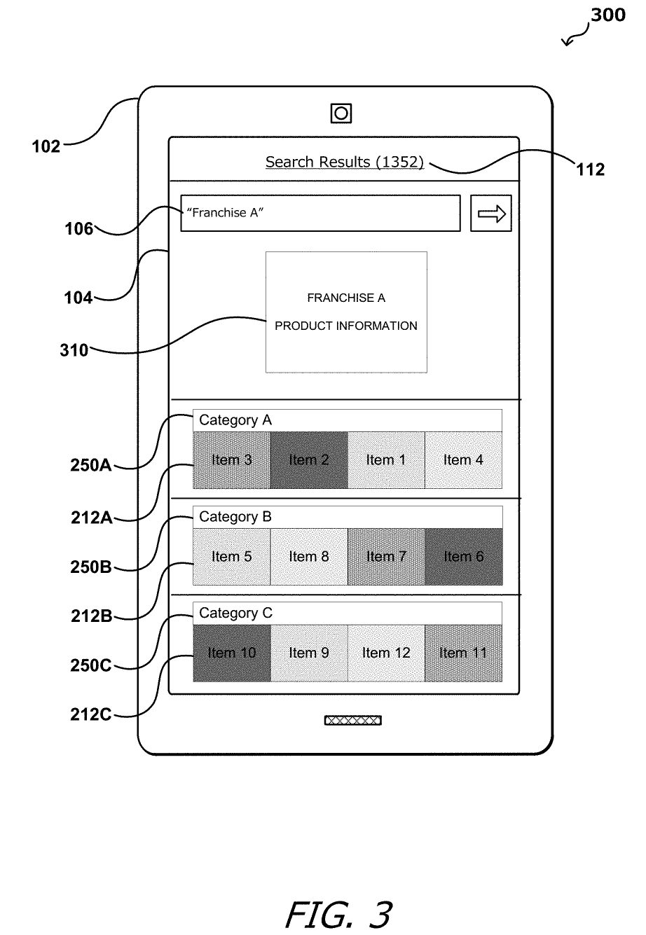

FIG. 3 illustrates an exemplary interface of a display 104 including visually diverse category representations of items 212A-212C across a variety of categories 250A-250C related to a search query 106 in accordance with various embodiments. As shown in FIG. 3, the interface displays the search query 106, product information related to the search query (e.g., a summary of the movie franchise or an overview of the types of content contained therein) 310, and a summary of the search results through a diverse cross-category summary of visually diverse items 212A-212C. The number of categories and the number of items within categories can be determined by the size and shape of the display 104 of the computing device 102 such that a different number of items and/or categories may be displayed in different embodiments. Moreover, each of the visually diverse items is presented through an image associated with each item and a description of the corresponding item other than the category indicator 250A-250B may or may not be provided. The categories and their placement upon the display screen may be selected based on the set of results within the result set as discussed above and the placement of the categories and their order may be determined based on a ranking of the categories and/or through the diversity or rankings of the items contained therein. Moreover, the order of the presented items (items 1-12) organized from left to right (or in some embodiments, top to bottom, bottom to top, right to left, etc.) may be determined based on the rank of each of the selected items. Thus, even though the items are obtained from different similarity groupings amongst the various categories of items, the order presented may be based on item rankings between categories, image similarity (or diversity) between categories, and/or through any other suitable method.

As described above in reference to FIG. 2C, the visually diverse category representations of items includes one image from each of the similarity groupings of items to ensure the items displayed are visually diverse across one or more attributes. Accordingly, embodiments provide a visual summary of a variety of categories and provide visually diverse examples of the items within those categories. Further, as described above, the categories and items contained therein are selected based on rankings and relevance determinations that incorporate behavioral user data including click-through rates associated with the items, as well as diversity of visual attributes and relevance to the user. Thus, embodiments provide an efficient and intuitive interface for displaying the breadth and diversity of items within a set of search results. Further, because the items are selected across categories and the diversity of the selected items is based on the similarity of various items across one or more visual attributes, embodiments may ensure that different items are displayed across the various categories and images. Accordingly, duplicate and/or similar images will not be selected and displayed as may be the case if the diversity is not maintained between selected images to present.

Note that the techniques described herein are not limited to product information pages related to particular types of search queries and the techniques disclosed herein may be used to display a sample or cross-section of diverse cross-category items within any result set. For example, embodiments may be used to preview result sets before a user views a set of data and/or may be used any time a user would like to sample the diversity of a set of results without browsing and/or clicking through each of the larger set of content.

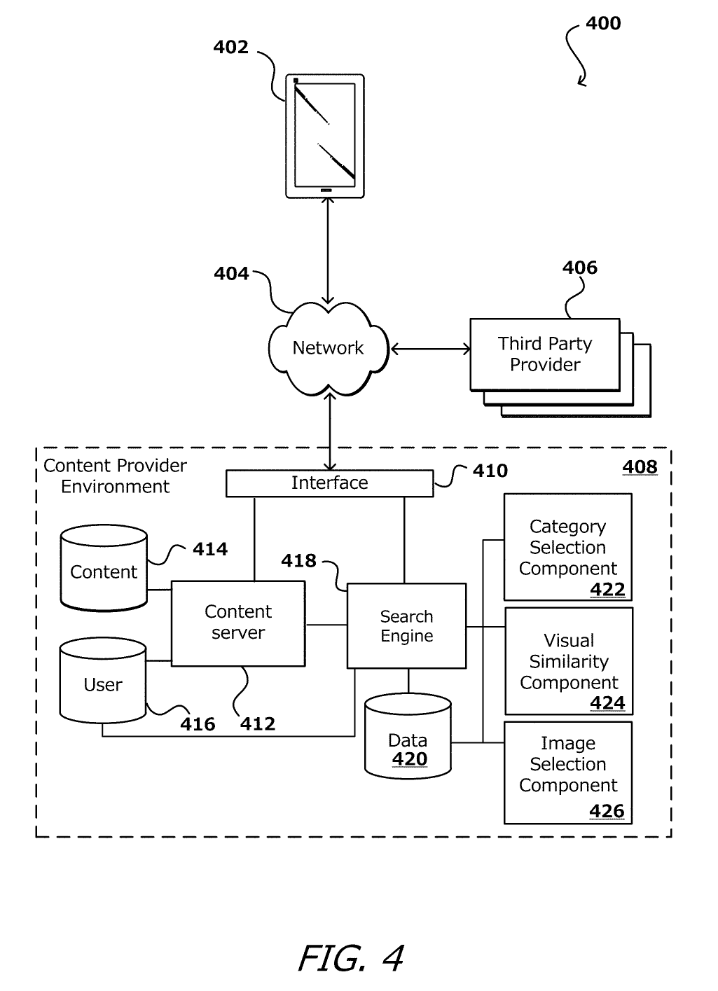

FIG. 4 illustrates an example environment 400 for determining visually diverse items related to a search query that can be utilized in accordance with various embodiments. In order to determine visually diverse items, in at least some embodiments, some analysis of items in a result set related to a search query is performed to determine information about the visual characteristics of the items in order to group the items by visual similarity. As shown in the example of FIG. 4, a user is able to use a client device 402 to submit a request including a search query related to items stored in one or more data stores in the environment, across at least one network 404. The request can be received when a user submits a search query from a third party provider 406 or content provider environment 408. A search query may be submitted through any suitable method (e.g., a text query, a voice request, etc.). Although a portable computing device (e.g., an electronic book reader, smart phone, or tablet computer) is shown as the client device, it should be understood that any electronic device capable of receiving, determining, and/or processing input can be used in accordance with various embodiments discussed herein, where the devices can include, for example, desktop computers, notebook computers, personal data assistants, video gaming consoles, television set top boxes, wearable computers (i.e., smart watches and glasses) and portable media players, among others.

The at least one network 404 can include any appropriate network, such as may include the Internet, an Intranet, a local area network (LAN), a cellular network, a Wi-Fi network, and the like. The request can be sent to an appropriate content provider environment 408, which can provide one or more services, systems, or applications for processing such requests. The content provider can be any source of digital or electronic content, as may include a website provider, an online retailer, a video or audio content distributor, an e-book publisher, and the like.

In this example, the request is received to a network interface layer 410 of the content provider environment 408. The network interface layer can include any appropriate components known or used to receive requests from across a network, such as may include one or more application programming interfaces (APIs) or other such interfaces for receiving such requests. The network interface layer 410 might be owned and operated by the provider, or leveraged by the provider as part of a shared resource or “cloud” offering. The network interface layer can receive and analyze the request from the client device 402, and cause at least a portion of the information in the request to be directed to an appropriate system or service, such as a content server 412 (e.g., a Web server or application server), among other such options. In the case of webpages, for example, at least one server 412 might be used to generate code and send content for rendering the requested Web page. In cases where processing is to be performed, such as to generate search results, perform an operation on a user input, verify information for the request, etc., information might also be directed to at least one other server for processing, for example search engine 418. The servers or other components of the environment might access one or more data stores, such as a user data store 416 that contains information about the various users, and one or more content repositories 414 storing content able to be served to those users.

The search engine 418 may receive the request from the content server and may determine a search result set of content items that includes multiple categories of items. The search engine 418 may receive the search result set of content from the content serve or may search the content data store 414 or the data store 420 for matching content items to a received search query. Since the search result set is associated with multiple different categories of information the search engine 418 may determine that techniques described herein should be applied to ensure a visually diverse representative set of images are presented to the user for the set of search results. Accordingly, the search engine 418 may provide the result set to a category selection component 422 for identification and selection of a plurality of categories in which to segment the result set. The search engine may interface with the category selection component 422 through any suitable manner in order to perform the functionality described herein.

The category selection component 422 can be used to identify types of categories associated with a result, determine a rank of the types of categories, and select the categories for segmentation of the result set as described herein in reference to FIG. 2C. For example, the category selection component 422 may analyze the result set of items associated with the search query and determine meaningful hierarchical cross-sections of the item result set and/or select meaningful categories and sub-categories of the result set in order to identify categories to select and display for the set of search results. The category selection component 422 may incorporate aggregated user data from other users, session data of the user, user profile data, cross-sections of users with similar interests or behavior to the user, and/or any other suitable product, browsing, and/or information available to the provider in determining which types of categories in which to select and segment the result set. Additionally, the category selection component 422 may determine the order that the categories are displayed as well as the order that the images and/or items are displayed in with respect to each category. For example, the images and categories may be presented from top to bottom (for categories) and left to right (for items within those categories) according to a ranking score that is determined by the category selection component. Accordingly, the category selection component 422 may rank each of the identified categories based on the set of items selected within each similarity grouping using visual aesthetics (e.g., based on aggregated previous user behavior in response to the images), a number of items within each of the identified categories, relevance to the search query, and information about the user or users with similar behavioral patterns to the user. Additionally, in some embodiments, items that otherwise have less visibility in the catalog but that have been successful may be specifically boosted to provide a broader sample of the result set than users traditionally experience.

Accordingly, the category selection component 422 may return a set of categories or types of categories, a set of items from the search result set associated with each set of categories, a rank for each of the categories, and/or any other suitable information to the search engine 418 for providing to a visual similarity component 424 to identify the visual similarity between images within each selected category identified by the category selection component 422. Additionally and/or alternatively, in some embodiments, the categories and/or set of results associated with each selected category may be directly provided to a visual similarity component 424 that is configured to identify the visual similarity between items within each selected category.

The visual similarity component 424 can be used to determine the visual similarity between a set of items within one or more of the selected categories. The visual similarity component 424 may use any suitable image comparison techniques to identify visual similarity between a set of results within one or more selected categories. For example, the visual similarity component may use a data store 420 that has been built to include one or more feature descriptors to describe features of an image (such as, color, content, character, pattern, style, etc.). In one example, the feature descriptors can be generated by a convolutional neural network (CNN) that can be trained using images of items that include metadata. For example, the CNN may be trained to perform object recognition using images of items, media content, people, characters, faces, cars, boats, airplanes, buildings, fruits, vases, birds, animals, furniture, clothing, etc. In certain embodiments, training a CNN may involve significant use of computation resources and time, such that this may correspond to a preparatory step to servicing search requests and/or performed relatively infrequently with respect to search request servicing and/or according to a schedule. An example process for training a CNN for generating descriptors describing visual features of an image in a collection of images begins with building a set of training images. In accordance with various embodiments, each image in the set of training images can be associated with an object label describing an object depicted in the image or a subject represented in the image. According to some embodiments, training images and respective training object labels can be located in a data store 420 that includes images of a number of different objects, wherein each image can include metadata. The metadata can include, for example, the title and description associated with the objects. The metadata can be used to generate object labels that can be used to label one or more objects or subjects represented in the image.

The visual similarity component 424 may include a training component can that may utilize the training data set (i.e., the images and associated labels) to train the CNN. In accordance with various embodiments, the CNN can be used to determine items (e.g., products, scenes, characters, etc.) in an image. As further described, CNNs include several learning layers in their architecture. A query image from the training data set is analyzed using the CNN to extract a feature vector from the network before the classification layer. This feature vector describes items shown in the image. This process can be implemented for each of the images in the data set, and the resulting feature vectors can be stored in a data store 420 and used by the visual similarity component 424 to identify visually similar images within a result set.

As additional items are added related to the data store 420, the images associated with those items can be analyzed and object descriptors and/or feature descriptors associated with the images can be determined. For example, when the image is received, a set of object descriptors may be obtained or determined for the image. For example, if the image is not part of an electronic catalog and does not already have associated feature descriptors, the system may generate feature descriptors for the image in a same and/or similar manner as the feature descriptors are generated for the collection of images, as described. Also, for example, if the image is already a part of the collection then the feature descriptors for the image may be obtained from the appropriate data store. Using the clustered feature vectors and corresponding visual words determined for the training images, the feature vector of the image can be determined and stored as being associated with the image for future use. The image can also be analyzed using the CNN to extract a feature vector from the network where the feature vector describes the item represented in the image.

Accordingly, the visual similarity component 424 may use the feature vectors stored in the data store 420 associated with each image to determine visual similarity between the images in the result set. For instance, since feature vectors have been determined, comparing images can be accomplished by comparing the feature vectors of the images of a result set. According to some embodiments, dot product comparisons are performed between the feature vectors of the images of the result set. The dot product comparisons are then normalized into similarity scores. As described, a feature vector includes one or more feature descriptors. After similarity scores are calculated between the different types of feature vectors of the images, the similarity scores can be combined. For example, the similarly scores may be combined by a linear combination or by a tree-based comparison that learns the combinations. It should be appreciated that instead of a dot product comparison, any distance metric could be used to determine distance between the different types of feature descriptors, such as determining the Euclidian distance between the feature descriptors.

In some embodiments, the visual similarity component 424 may include a weighting component that is configured to calculate weights for the different types of similarity scores. For example, a weight for each dimension (color, size, shape, texture, pattern, feature descriptors, etc.) may range between 0 and 1. A weight of zero would eliminate that dimension from being used to identify visually related content items and a weight of one would maximize the influence of that dimension. However, as described above, neither dimension alone adequately identifies visually related items. Accordingly, a minimum weight may be defined for each dimension. In some embodiments, the minimum weight may be determined heuristically by analyzing recommended visually related items, user feedback, or other feedback sources. After the combined similarity scores are determined, a set of nearest feature vectors may be selected to obtain each of the similarity groups for each subset of items.

Accordingly, the visual similarity component 424 may return groupings of visually similar items within each set of selected categories to the search engine 418 for providing to an image selection component 426 to identify the images to select from each similarity grouping. Additionally and/or alternatively, in some embodiments, the similarity groupings of items within each subset associated with each selected category may be directly provided to the image selection component 426 that is configured to rank, select, and organize the visually diverse images for display.

The image selection component 426 may use the similarity groupings of visually similar items in order to select one or more of the items from each of the groupings. The image selection component may use any suitable process for identifying and selecting an image from each of the groupings. For example, the image selection component 426 may rank each of the images within each similarity group and select the highest ranked image from each of the groupings. The ranking may take into account relevance to the search query, relevance to the user based on behavioral data associated with the user, behavioral data associated with aggregated user activity across the provider over time, and/or any other relevant information. Additionally, the image may be selected based on the placement within the similarity groupings provided by the visual similarity component 424. For example, in some embodiments, the image selection component may select the item closest to the middle of the image similarity grouping for each grouping. Additionally, the image selection component may implement different selection techniques based on the number of images that are to be selected from each grouping. For example, in some embodiments, multiple items can be selected from each grouping to still provide visually diverse items but to provide more examples from the cross-sections of the data. Accordingly, two or more items may be selected from each grouping in some embodiments and those items may be selected by taking two items that are associated with images that are most dissimilar (i.e., furthest from one another within the grouping) or may be selected based on rank without regard to the similarity between items within the similarity groupings.

Additionally, in some embodiments, the image selection component 426 may compare the diversity and/or similarity between images across those selected images from each of the category similarity sub-groupings before providing the selected images for display. For example, in some embodiments, the diverse set of items that are selected from each similarity sub-groupings associated with each of the categories may be compared to one another within the same category or within multiple categories before the images are presented. As such, the image selection component may compare selected images between representative sets of visually diverse items to ensure that there are no duplicate images present between two or more representative sets of visually diverse items associated with the result set. For instance, the similarity scores may be compared or a new similarity comparison may be accomplished with different dimensions and/or features highlighted to ensure that the images are sufficiently diverse across the final result set of visually diverse images selected for display. Further, in some embodiments, the product identifiers (e.g., product numbers, names, etc.) may be compared to ensure the same product is not being displayed and/or that two images associated with the same product are not being displayed. If the objects are the same or if the images are too similar across selected images, the image selection component 426 may obtain a replacement item from the similarity grouping to represent the similarity group. Once the visually diverse items have been selected, the items and/or images associated with the items can be returned to the search engine 418 for providing to the computing device.

Accordingly, the search engine 418 may return the set of visually diverse items and/or images associated with those items to the user through a response to the computing device 402. As such, in response to the search query, the user can receive a set of results from the catalog of items (e.g., products, media, services etc.) that are associated with the search query and are a representative, diverse, and interesting cross-section of the search results for review.

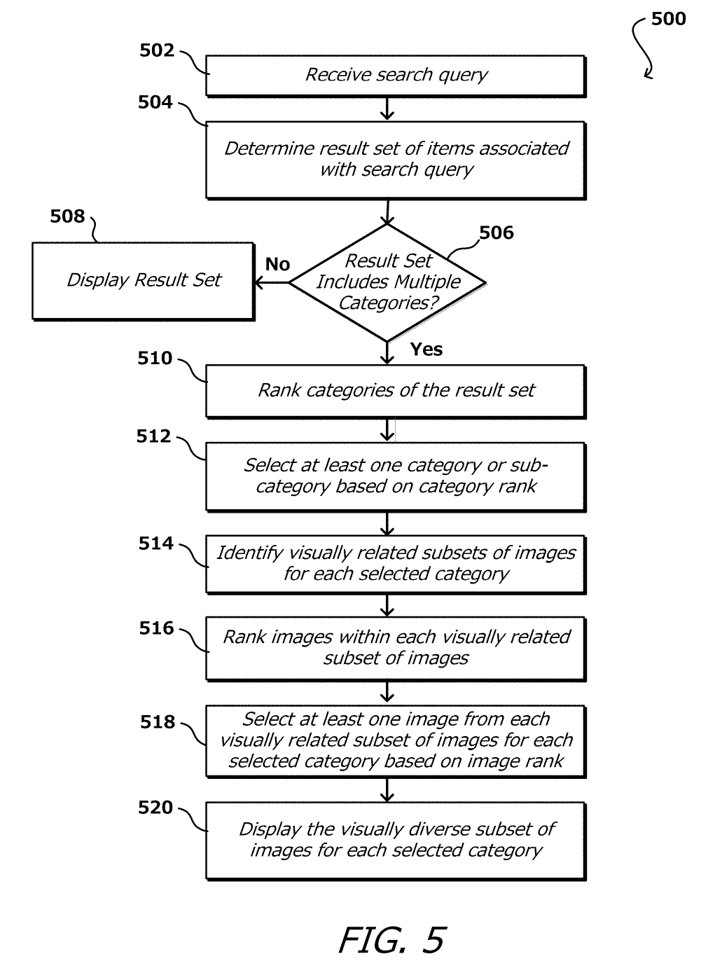

FIG. 5 illustrates an example process 500 for selecting a diverse set of representative images associated with a result set of a search query that can be utilized in accordance with various embodiments. As shown in FIG. 5, a search query can be received 502. As discussed, the search query may be received from a user device by, e.g., submitting a text search string, etc. The search query is associated with a set of items of a catalog of items provided through an electronic marketplace. For example, the search query can be for a movie franchise and the set of items can be associated with the movie franchise. In response to receiving the search query, the set of items can be determined 504. The set of items can be associated with a plurality of categories (e.g., movies, television shows, clothing, novelty gifts, toys, etc.). Whether the result set includes a threshold number of categories (e.g., multiple categories) can be determined 506. If the result set does not include multiple categories or a threshold number of categories, the result set can be displayed 508. However, if the result set is associated with multiple categories or a threshold number of categories, the categories of the result set can be identified 510. At least one category or sub-category of the result set can be selected 512 based on a ranking of the categories associated with the result set. The number of categories that are selected may be based on the size and/or dimensions of the user device. Visually related subsets of images for each selected category can be identified 514. The images within each of the subsets of visually related images can be ranked 516. Once the visually related subsets are ranked, one image from each visually related subset of images for each selected category can be selected 518 based on the image rank. The number of images selected from each subset of visually related images can be determined based on the size and dimensions of the user device. Once a visually diverse subset of images has been selected, the visually diverse subset of images for each selected category may be displayed 520.

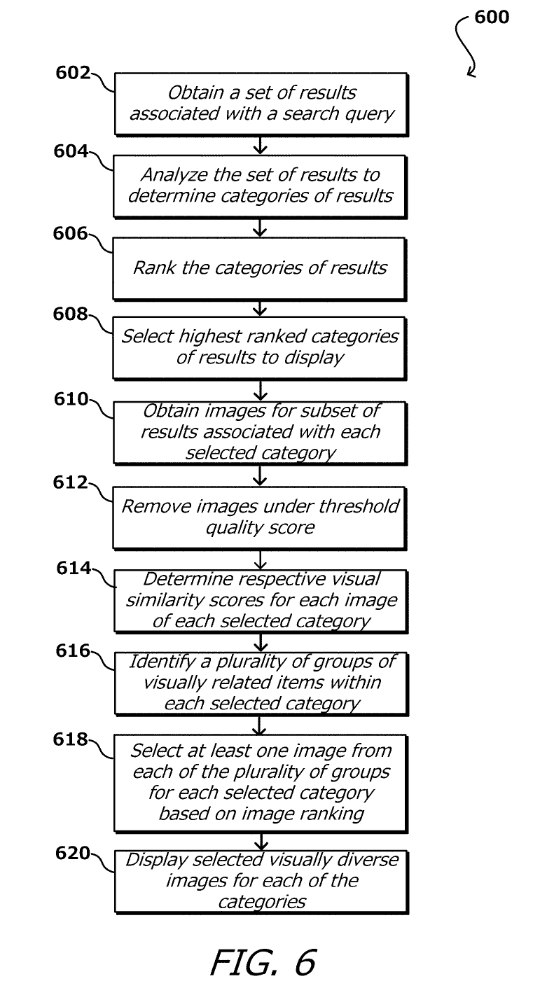

FIG. 6 illustrates an example process 600 for determining groupings of visually related items and using the groupings of visually related items to select visually diverse items across categories related to a set of results that can be utilized in accordance with various embodiments. As shown in FIG. 6, a set of results associated with a search query can be obtained 602. The set of results can be analyzed 604 to determine categories of results associated with the result set. Once the categories of results are determined, the categories can be ranked 606. For example, the ranking each of the plurality of categories based at least in part on at least one of a number of items within each of the plurality of categories, a relevance score for the items within each of the plurality of categories, and behavioral patterns of users with the items within each of the plurality of categories. Once the categories are ranked, a predetermined number of highest ranked categories to display can be selected 608. In some embodiments, the predetermined number of highest ranked categories can be based at least one of a type or a size of the display element of the computing device. Images associated with each selected category can be obtained 610. For example, in some embodiments, at least one subset of items associated with at least one of the plurality of categories can be selected and at least one set of images corresponding to the at least one subset of items associated with the respective selected categories of items can be obtained. In some embodiments, each image of the at least one set of images can be analyzed to determine respective visual attributes where the respective visual attributes correspond to one or more visual aspects of a respective image. For example, one or more of the plurality of images may be removed 612 based on a visual quality score of the respective image being below a quality threshold. The visual quality score can be determined based on the number of pixels in the image, the dimensions and/or size of the image, the file format and/or compression format used for a file associated with the image, and/or through any other suitable method. For example, the visual similarity component may be configured to process each image in the result set of images to determine a visual quality score for each image based on the characteristics of the image itself (e.g., sharpness, noise within the images (pixel level variations in the digital images), etc.). Additionally and/or alternatively, the visual similarity component may determine a visual quality score for each image based on characteristics of the stored image file (e.g., the dimensions of the image, the amount of information in the image, the compression technique for the file, etc.).

Further, in some embodiments, the images can be analyzed to determine 614 respective visual similarity scores for each image of each selected category. In some embodiments, a set of visual similarity scores for each image of can be determined based at least in part on the respective visual attributes where the visual similarity score may indicate a visual similarity of one image from the respective set of images to another image of the respective set of images. In some embodiments, a plurality of groups of visually related items for the respective set of images can be generated or identified 616 based at least in part on the set of visual similarity scores for each image. In some embodiments, the plurality of groups of visually related items may be generated by identifying a predetermined number of visually diverse images to select for each respective category and segmenting the respective set of images into a predetermined number of groups of visually related items where the predetermined number of groups of visually related items correspond to the predetermined number of visually diverse images to select for each respective category. An image from each of the plurality of groups of visually related items may be selected 618 based on an image ranking algorithm. In some embodiments, the image ranking algorithm may rank each image of the subset of images based at least in part on at least one of session data associated with a user, a relevance score for the content item associated with the respective image, and behavioral patterns of users with the content item associated with the respective image. Once the selected visually diverse images are selected, the visually diverse images may be displayed 620 for each of the categories. For example, in some embodiments, the set of visually diverse items may be displayed on a display element of a computing device.

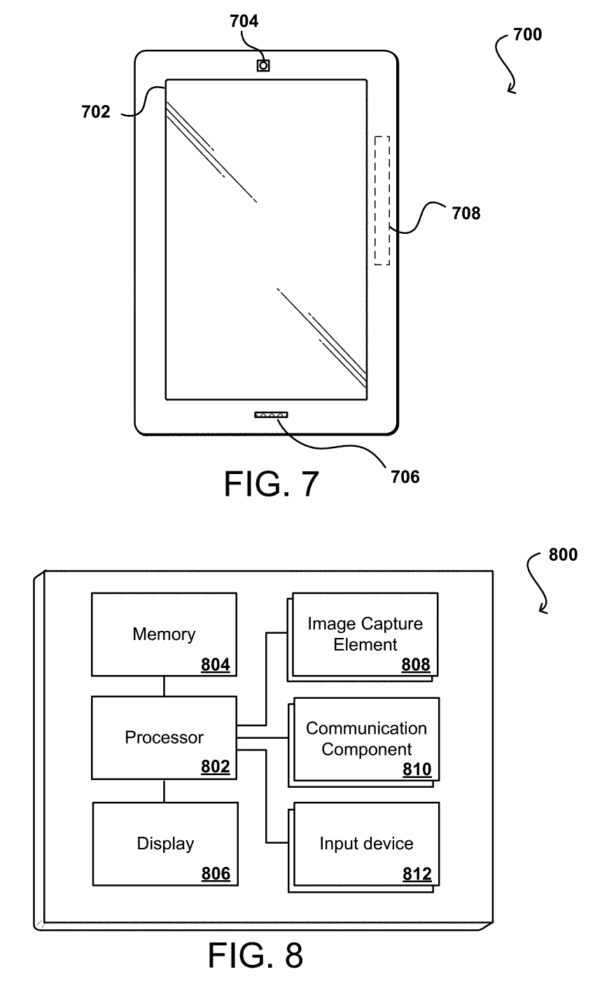

FIG. 7 illustrates an example computing device 700 that can be used in accordance with various embodiments. Although a portable computing device (e.g., a smart phone, an electronic book reader, or tablet computer) is shown, it should be understood that any device capable of receiving and processing input can be used in accordance with various embodiments discussed herein. The devices can include, for example, desktop computers, notebook computers, electronic book readers, personal data assistants, cellular phones, video gaming consoles or controllers, wearable computers (e.g., smart watches or glasses), television set top boxes, and portable media players, among others.

In this example, the computing device 700 has a display screen 704 and an outer casing 702. The display screen under normal operation will display information to a user (or viewer) facing the display screen (e.g., on the same side of the computing device as the display screen). As discussed herein, the device can include one or more communication components 706, such as may include a cellular communications subsystem, Wi-Fi communications subsystem, BLUETOOTH® communication subsystem, and the like. FIG. 8 illustrates a set of basic components of a computing device 800 such as the device 700 described with respect to FIG. 7. In this example, the device includes at least one processor 802 for executing instructions that can be stored in a memory device or element 804. As would be apparent to one of ordinary skill in the art, the device can include many types of memory, data storage or computer-readable media, such as a first data storage for program instructions for execution by the at least one processor 802, the same or separate storage can be used for images or data, a removable memory can be available for sharing information with other devices, and any number of communication approaches can be available for sharing with other devices. The device typically will include at least one type of display element 806, such as a touch screen, electronic ink (e-ink), organic light emitting diode (OLED) or liquid crystal display (LCD), although devices such as portable media players might convey information via other means, such as through audio speakers. The device can include at least one communication component 808, as may enabled wired and/or wireless communication of voice and/or data signals, for example, over a network such as the Internet, a cellular network, a Wi-Fi network, BLUETOOTH®, and the like. The device can include at least one additional input device 810 able to receive conventional input from a user. This conventional input can include, for example, a push button, touch pad, touch screen, wheel, joystick, keyboard, mouse, trackball, camera, microphone, keypad or any other such device or element whereby a user can input a command to the device. These I/O devices could even be connected by a wireless infrared or Bluetooth or other link as well in some embodiments. In some embodiments, however, such a device might not include any buttons at all and might be controlled only through a combination of visual and audio commands such that a user can control the device without having to be in contact with the device.

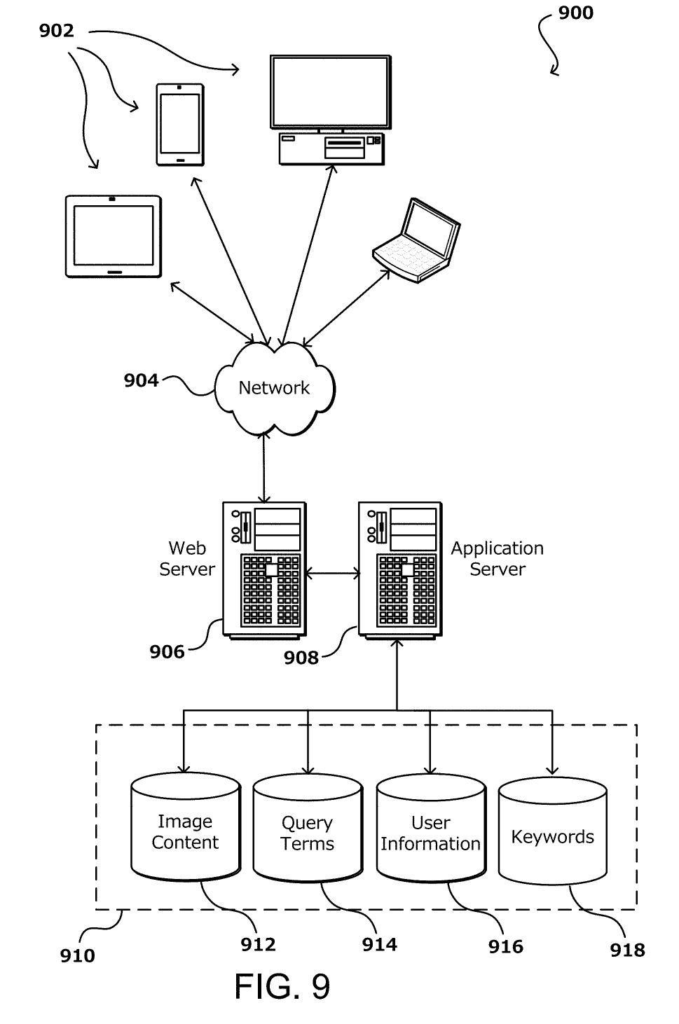

As discussed, different approaches can be implemented in various environments in accordance with the described embodiments. For example, FIG. 9 illustrates an example of an environment 900 for implementing aspects in accordance with various embodiments. As will be appreciated, although a Web-based environment is used for purposes of explanation, different environments may be used, as appropriate, to implement various embodiments. The system includes an electronic client device 902, which can include any appropriate device operable to send and receive requests, messages or information over an appropriate network 904 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 906 for receiving requests and serving content in response thereto, although for other networks, an alternative device serving a similar purpose could be used, as would be apparent to one of ordinary skill in the art.

The illustrative environment includes at least one application server 908 and a data store 910. It should be understood that there can be several application servers, layers or other elements, processes or components, which may be chained or otherwise configured, which can interact to perform tasks such as obtaining data from an appropriate data store. As used herein, the term “data store” refers to any device or combination of devices capable of storing, accessing and retrieving data, which may include any combination and number of data servers, databases, data storage devices and data storage media, in any standard, distributed or clustered environment. The application server 908 can include any appropriate hardware and software for integrating with the data store 910 as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server 906 in the form of HTML, XML or another appropriate structured language in this example. The handling of all requests and responses, as well as the delivery of content between the client device 902 and the application server 908, can be handled by the Web server 906. It should be understood that the Web and application servers are not required and are merely example components, as structured code discussed herein can be executed on any appropriate device or host machine as discussed elsewhere herein.

The data store 910 can include several separate data tables, databases or other data storage mechanisms and media for storing data relating to a particular aspect. For example, the data store illustrated includes mechanisms for storing content (e.g., production data) 912 and user information 916, which can be used to serve content for the production side. The data store is also shown to include a mechanism for storing log or session data 914. It should be understood that there can be many other aspects that may need to be stored in the data store, such as page image information and access rights information, which can be stored in any of the above listed mechanisms as appropriate or in additional mechanisms in the data store 910. The data store 910 is operable, through logic associated therewith, to receive instructions from the application server 908 and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device 902. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 9. Thus, the depiction of the system 900 in FIG. 9 should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method, comprising:
receiving a search query, the search query associated with a set of items of a catalog of items provided through an electronic marketplace;
determining a plurality of categories associated with the set of items;
selecting at least one subset of items associated with at least one of the plurality of categories;
obtaining at least one set of images corresponding to the at least one subset of items associated with the respective selected categories of items;
analyzing each image of the at least one set of images to determine respective visual attributes, the respective visual attributes corresponding to one or more visual aspects of a respective image;
determining a set of visual similarity scores for each image of the at least one set of images based at least in part on the respective visual attributes, a visual similarity score indicating a visual similarity of one image from the respective set of images to another image of the respective set of images;
generating a plurality of groups of visually related items for the respective set of images based at least in part on the set of visual similarity scores for each image;
selecting a set of visually diverse items for each set of images within each respective category, the set of visually diverse items including one image from each of the plurality of groups of visually related items; and
causing the set of visually diverse items to be displayed on a display element of a computing device.

2. The method of claim 1, further comprising:
ranking each of the plurality of categories based at least in part on at least one of a number of items within each of the plurality of categories, a relevance score for the items within each of the plurality of categories, and behavioral patterns of users with the items within each of the plurality of categories; and
selecting the at least one of the plurality of categories based at least in part on the ranking of each of the plurality of categories.

3. The method of claim 1, further comprising:
removing one or more of the plurality of images based on a visual quality score of the respective image being below a quality threshold.

4. The method of claim 1, wherein generating a plurality of groups of visually related items based at least in part on the set of visual similarity scores for each image further comprises:
identifying a predetermined number of visually diverse items to select for each respective category; and
segmenting the respective set of images into a predetermined number of groups of visually related items, the predetermined number of groups of visually related items corresponding to the predetermined number of visually diverse items to select for each respective category, and the set of images being segmented based at least in part on the set of visual similarity scores for each image.

5. The method of claim 2, wherein selecting at least one of the categories based at least in part on the ranking of each category further comprises:
selecting a predetermined number of highest ranked categories, the predetermined number being based on at least one of a type or a size of the display element of the computing device.

6. A server computing device, comprising:
a server computing device processor;
a memory device including instructions that, when executed by the server computing device processor, cause the server computing device to:
receive a search query, the search query being associated with a set of content items;
identify a subset of the set of content items;
obtain a subset of images corresponding to the subset of content items, each image of the subset of images including a representation of a content item from the subset of content items;
analyze each image of the subset of images to determine respective visual attributes, the respective visual attributes corresponding to one or more visual aspects of a respective image;
select a representative set of visually diverse items for the subset of images, the representative set of visually diverse items being selected based at least in part on the respective visual attributes of each respective image; and
cause the representative set of visually diverse items to be displayed on a display element of a computing device.

7. The computing device of claim 6, wherein the instructions, when executed further enable the computing device to:
determine a set of visual similarity scores for each image of the set of images based at least in part on the respective visual attributes, a visual similarity score indicating a visual similarity of one image from the set of images to another image of the set of images, the representative set of visually diverse items being selected based at least in part on the set of visual similarity scores for each image of the set of images.

8. The computing device of claim 7, wherein the instructions, when executed further enable the computing device to:
generate a plurality of groups of visually related items based at least in part on the set of visual similarity scores for each image, the set of representative visually diverse items being selected by including one image from each of the plurality of groups of visually related items.

9. The computing device of claim 8, wherein the instructions, when executed further enable the computing device to:
rank each image of the subset of images based at least in part on at least one of session data associated with a user, a relevance score for the content item associated with the respective image, and behavioral patterns of users with the content item associated with the respective image, the selection of the one image from each of the plurality of groups of visually related items based at least in part on the ranking of each respective image.

10. The computing device of claim 6, wherein the instructions, when executed further enable the computing device to:
remove one or more of the subset of images based on a visual quality score of the respective image being below a quality threshold.

11. The computing device of claim 6, wherein identifying a subset of the set of content items further comprises:
determining a plurality of categories associated with the set of content items;
ranking each of the plurality of categories based at least in part on at least one of a number of content items within each of the plurality of categories, a relevance score for the content items within each of the plurality of categories, and behavioral patterns of users with the content items within each of the plurality of categories; and
selecting at least one of the plurality of categories based on the ranking of each of the plurality of categories.

12. The computing device of claim 8, wherein the instructions, when executed further enable the computing device to:
update the representative set of visually diverse items to include a different image from each of the plurality of groups of visually related items.

13. The computing device of claim 6, wherein the instructions, when executed further enable the computing device to:
compare images associated with the representative set of visually diverse items to images associated with a second representative set of visually diverse items associated with a second subset of the set of content items to ensure no duplicate images are present between the representative set of visually diverse items and the second representative set of visually diverse items.

14. The computing device of claim 6, wherein the instructions, when executed further enable the computing device to:
determine dimensions of a viewable area of the display screen; and
determine a number of content items in the representative set of visually diverse items to display based at least in part on the dimensions of the viewable area.

15. The computing device of claim 14, wherein the instructions, when executed further enable the computing device to:
determine a change to the dimensions of the viewable area of the display screen; and
update the number of content items in the representative set of visually diverse items based at least in part on the change to the dimensions.

16. A method, comprising:
receiving a search query, the search query being associated with a set of content items;
identifying a subset of the set of content items;
obtaining a subset of images corresponding to the subset of content items, each image of the subset of images including a representation of a content item from the subset of content items;
analyzing each image of the subset of images to determine respective visual attributes, the respective visual attributes corresponding to one or more visual aspects of a respective image;
selecting a representative set of visually diverse items for the subset of images, the representative set of visually diverse items being selected based at least in part on the respective visual attributes of each respective image; and
causing the representative set of visually diverse items to be displayed on a display element of a computing device.

17. The method of claim 16, further comprising:
determine a set of visual similarity scores for each image of the set of images based at least in part on the respective visual attributes, a visual similarity score indicating a visual similarity of one image from the set of images to another image of the set of images, the representative set of visually diverse items being selected based at least in part on the set of visual similarity scores for each image of the set of images.

18. The method of claim 17, further comprising:
generating a plurality of groups of visually related items based at least in part on the set of visual similarity scores for each image, the set of representative visually diverse items being selected by including one image from each of the plurality of groups of visually related items.

19. The method of claim 18, further comprising:
ranking each image of the subset of images based at least in part on at least one of session data associated with a user, a relevance score for the content item associated with the respective image, and behavioral patterns of users with the content item associated with the respective image, the selection of the one image from each of the plurality of groups of visually related items based at least in part on the ranking of each respective image.

20. The method of claim 16, further comprising:
determining a plurality of categories associated with the set of content items;
ranking each of the plurality of categories based at least in part on at least one of a number of content items within each of the plurality of categories, a relevance score for the content items within each of the plurality of categories, and behavioral patterns of users with the content items within each of the plurality of categories; and
selecting at least one of the plurality of categories based on the ranking of each of the plurality of categories.
